(19) United States
(12) Patent Application Publication
(10) Pub. No.: US 2008/0035895 A1
(43) Pub. Date: Feb. 14, 2008

(54) Silver powder and method for producing same

(76) Inventors: Kozo Ogi, Honjo-shi (JP); Yoshio Hasegawa, Funabashi-shi (JP)

Correspondence Address: BACHMAN & LAPOINTE, P.C., 900 CHAPEL STREET, SUITE 1201, NEW HAVEN, CT, 06510, US

(21) Appl. No.: 11/906,950

(22) Filed: Oct. 3, 2007

Related U.S. Application Data
(62) Division of application No. 11/066,345, filed on Feb. 25, 2005.

(30) Foreign Application Priority Data
Feb. 26, 2004 (JP) 2004-051009

(51) Int. Cl. H01B 1/02

(52) U.S. Cl. 252/514

(57) ABSTRACT

There is provided a method for a silver powder capable of decreasing the viscosity of a photosensitive paste using the silver powder and improving the film state, sensitivity and linearity of the paste even if the particle diameter of the silver powder is small. The surface of a silver powder produced by a wet reducing method is smoothed by a surface smoothing process for mechanically causing particles of the silver powder to collide with each other, and thereafter, silver agglomerates are removed by classification. The surface smoothing process is carried out by putting a dried silver powder into an apparatus, which is capable of mechanically fluidizing particles, e.g., a mixer or mill such as a cylindrical high-speed mixer, for mechanically causing the particles to collide with each other.

### BACKGROUND OF THE INVENTION

1. Field of the Invention

The present invention generally relates to a silver powder and a method for producing the same. More specifically, the invention relates to a silver powder for a conductive paste for use in electronic parts, such as internal electrodes of multilayer capacitors, conductive patterns of circuit boards, and electrodes of substrates for plasma display panels, and a method for producing the same.

2. Description of the Prior Art

As a conventional conductive paste for use in electronic parts, such as internal electrodes of multilayer capacitors, conductive patterns of circuit boards, and electrodes of substrates for plasma display panels (PDPs), there is used a silver paste produced by mixing a silver powder and a glass frit in an organic vehicle and kneading them so as to the silver powder in the vehicle. In order to decrease the size of these electronic parts and/or to form a conductive pattern having a high density and fine lines, it is required that a silver powder for a conductive paste has reasonably small particle diameters and a reasonably narrow particle size distribution.

As a method for producing such a silver powder for a conductive paste, there is known a wet reducing method for adding an alkali or a complexing agent to an aqueous silver salt containing solution to form a silver oxide containing slurry or an aqueous silver complex salt containing solution, and thereafter, adding a reducing agent to the silver oxide containing slurry or the aqueous silver complex salt containing solution to deposit a silver powder by reduction. As a method for producing a silver powder having desired particle diameters for a conductive paste, there is known a method for adding a complexing agent to an aqueous silver salt containing solution to form an aqueous silver complex salt containing solution (an aqueous silver ammine complex solution), and thereafter, adding a reducing agent to the aqueous silver salt containing solution in the presence of a very small amount of organic metal compound to produce a silver powder having desired particle diameters (see, e.g., Japanese Patent Laid-Open No. 8-176620). According to this method, it is possible to obtain spherical silver particles having desired particle diameters by changing the amount of the organic metal compound to be added.

However, if a silver powder having small particle sizes is produced by a conventional silver powder producing method, the viscosity of a conductive paste using the silver powder increases as the particle diameter of the silver powder decreases. That is, there is a problem in that it is not possible to produce a silver powder capable of decreasing the viscosity of a conductive paste using the silver powder even if the particle diameter of the silver powder is small.

In order to solve this problem, there is proposed a method for producing a silver powder, which can smooth irregularities and angular portions on the surface of particles of the silver powder without substantially changing the particle diameter and particle size distribution of the silver powder by carrying out a surface smoothing process for mechanically causing the particles to collide with each other, so that it is possible to decrease the particle diameter of the silver powder and the viscosity of a conductive paste using the silver powder (see, e.g., Japanese Patent Laid-Open No. 2002-80901).

On the other hand, as a method for forming an electrode of a substrate for a plasma display panel or the like, there is proposed a method for forming a fine pattern by a photolithography method using a photosensitive paste which is obtained by adding a photosensitive resin serving as an organic component to a conductive paste (see, e.g., Japanese Patent Laid-Open No. 11-339554). As a photosensitive paste (a photo paste) for use in such a method for forming a fine pattern by the photolithography method, it is possible to use a paste using a silver powder produced by the method disclosed in Japanese Patent Laid-Open No. 2002-80901, and such a paste has a very excellent sensitivity. The reason for this is not clear, but it is considered that, since the surface of the silver powder produced by the method disclosed in Japanese Patent Laid-Open No. 2002-80901 is smooth, it is possible to decrease the irregular reflection of ultraviolet to precisely cure a desired region of a film of the paste to its deep part.

However, in recent years, electronic parts, such as electrodes of substrates for plasma display panels, are required to have a pattern having a higher density and finer lines, so that there are some cases where the film state and linearity of a photosensitive paste are not good even if the photosensitive paste uses a silver powder produced by the method disclosed in Japanese Patent Laid-Open No. 2002-80901. Thus, there are some cases where it is not possible to obtain a good burned film, so that it is not possible to provide a pattern having a higher density and finer lines.

### SUMMARY OF THE INVENTION

It is therefore an object of the present invention to eliminate the aforementioned problems and to provide a silver powder capable of decreasing the viscosity of a photosensitive paste using the silver powder and improving the film state, sensitivity and linearity of the paste even if the particle diameter of the silver powder is small, and a method for producing the same.

In order to accomplish the aforementioned and other objects, according to one aspect of the present invention, there is provided a method for producing a silver powder, the method comprising the steps of: producing a silver powder by a wet reducing method; smoothing a surface of the produced silver powder by a surface smoothing process for mechanically causing particles to collide with each other; and removing silver agglomerates by a classification.

In this method, the wet reducing method may comprise the steps of: adding an alkali or complexing agent to an aqueous silver salt containing solution to form a silver oxide containing slurry or an aqueous silver complex salt containing solution; and thereafter, adding a reducing agent to the slurry or solution to deposit a silver powder by reduction. The silver powder preferably has a mean particle diameter of 0.1 to 10 μm after the classification, and more preferably has a mean particle diameter of not greater than 5 μm after the classification. The classification preferably removes silver agglomerates having a size of greater than 15 μm, and more preferably removes silver agglomerates having a size of greater than 11 μm. The surface smoothing process is preferably carried out by means of a high-speed mixer.

According to another aspect of the present invention, there is provided a silver powder having a mean particle diameter of 0.1 to 10 μm and a maximum particle diameter of not greater than 15 μm, wherein the silver powder has a maximum particle diameter Dₘₐₓ measured by a grind gauge is not greater than 12.5 μm when the silver powder is used for preparing a paste, and wherein a mixture, which is obtained by mixing and dispersing 80 wt % of the silver powder in 20 wt % of an epoxy resin having a viscosity of 0.2 to 0.6 Pa·sec at 25° C. has a viscosity of not greater than 135 Pa·sec when the viscosity is measured by an E-type viscometer at 25° C. and 1 rpm.

Preferably, in this silver powder, the maximum particle diameter of the silver powder is not greater than 11 μm, the maximum particle diameter Dₘₐₓ measured by the grind gauge is not greater than 7.5 μm, and the means particle diameter of the silver powder is not greater than 5 μm.

According to a further aspect of the present invention, where is provide a silver powder having a mean particle diameter of 0.1 to 10 μm and a maximum particle diameter of not greater than 15 μm, wherein the silver powder has a maximum particle diameter Dₘₐₓ measured by a grind gauge is not greater than 12.5 μm when the silver powder is used for preparing a paste, and wherein a mixture, which is obtained by mixing and dispersing 80 wt % of the silver powder in 20 wt % of an epoxy resin having a viscosity of 0.2 to 0.6 Pa, sec at 25° C. has a viscosity of not greater than 90 Pa sec when the viscosity is measured by an E-type viscometer at 25° C. and 3 rpm.

Preferably, in this silver powder, the maximum particle diameter of the silver powder is not greater than 11 μm, the maximum particle diameter Dₘₐₓ measured by the grind gauge is not greater than 7.5 μm, and the means particle diameter of the silver powder is not greater than 5 μm.

According to a still further aspect of the present invention, there is provided a silver powder produced by the above described method, wherein the silver powder has a maximum particle diameter Dₘₐₓ is not greater than 12.5 μm when the maximum particle diameter Dₘₐₓ is measured by a grind gauge if the silver powder is used for preparing a paste.

Preferably, in this silver powder, the maximum particle diameter Dₘₐₓ measured by the grind gauge is not greater than 7.5 μm.

According to the present invention, a surface smoothing process for mechanically causing particles of a silver powder, which is produced by a wet reducing method, to collide with each other is carried out. Thus, it is possible to smooth irregularities and angular portions on the surface of the silver powder without substantially changing the particle diameter and particle size distribution of the silver powder, so that it is possible to produce a silver powder capable of reducing the viscosity of a photosensitive paste and improving the sensitivity thereof when the photosensitive paste uses the silver powder even if the particle diameter of the silver powder is small. Moreover, if silver agglomerates are removed by a classification, it is possible to produce a silver powder capable of improving the film state and (linearity of a photosensitive paste using the silver powder. Thus, it is possible to greatly improve the film state and linearity of a photosensitive paste using a silver powder according to the present invention, so that it is possible to provide an electronic part having a pattern which has a high density and fine lines.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is an illustration for explaining silver agglomerates observed in a film state;

FIG. 2 is an illustration for explaining a comb-shaped pattern used for evaluating sensitivity; and

FIGS. 3A through 3C are illustrations for explaining linearity, which are enlarged views showing a line portion of the comp-shaped pattern of FIG. 2.

### DESCRIPTION OF THE PREFERRED EMBODIMENTS

In a preferred embodiment of a method for producing a silver powder according to the present invention, after a surface smoothing process for mechanically causing particles of a silver powder, which is produced by a wet reducing method, to collide with each other is carried out, silver agglomerates are removed by a classification.

The wet reducing method may be a method comprising the steps of adding an alkali or complexing agent to an aqueous silver salt containing solution to form a silver oxide containing slurry or an aqueous silver complex salt containing solution, and thereafter, adding a reducing agent to the slurry or solution to deposit a silver powder by reduction. In order to prevent the secondary cohesion of the silver powder to obtain monodisperse silver particles to improve characteristics of an electronic part which uses a conductive paste using the silver powder, the wet reducing method may include a process for adding a dispersing agent to a silver slurry obtained by deposition due to reduction, or a process for adding a dispersing agent to a water reaction system containing at least one of a silver salt and silver oxide before the silver powder is deposited by reduction. The dispersing agent may be one or more selected from the group consisting of fatty acids, fatty acid salts, surface active agents, organic metals, chelating agents and protective colloids.

The surface smoothing process is carried out by putting a dried silver powder into an apparatus, which is capable of mechanically fluidizing particles, to mechanically cause particles of the silver powder to collide with each other. In practice, a mixer or mill, such as a cylindrical high-speed mixer, e.g., a Henchel mixer, may be used for carrying out the surface smoothing process. The input amount of the silver powder, the revolving speed and kind of blades of the mixer or mill, and the processing time may be controlled to optimize the fluidization of particles and the smoothing of the shape of the surface due to collision. By this surface smoothing process, it is possible to smooth irregularities and angular portions on the surface of particles of the silver powder to decrease the viscosity of a conductive paste using the silver powder without substantially changing the particle diameter and particle size distribution of the silver powder. By this surface smoothing process, it is also possible to greatly improve the sensitivity of a photosensitive paste using the silver powder.

The classification may be a method capable of removing large silver agglomerates. As such methods, there are a method for causing particles of a silver powder to pass through meshes having a predetermined size (e.g., a method utilizing a sieve shaker or inplane sieve), and a method for separating particles of a silver powder by air flow. In view of the precision of removal of agglomerates, an air classification for separating a group of particles by air flow is preferably carried out. The air classification may be carried out by using any one of commercially available apparatuses based on gravity, inertia, centrifugal force or the like. Any one of such commercially available apparatuses may be suitably chosen in accordance with the desired size of particles to be removed, the particle size distribution of particles after removing agglomerates, the classification speed, the yields of the silver powder and so forth For example, such air classification apparatuses include a variable impactor, an elbow jet, a cyclotron and an acu-cut. In addition, any one of various pulverizers or mills may be used if it has an air classification function although pulverization or milling is not intended to be carried out. For example, such pulverizers or mills include a CF mill and a jet mill. Moreover, the above described air classification apparatuses may be combined.

Examples of a silver powder and a method for producing the same according to the present invention will be described below in detail.

### EXAMPLE 1

To 3600 ml of an aqueous solution containing 12 g/l silver nitrate as silver ions, 375 ml of industrial aqueous ammonia was added to form an aqueous silver ammine complex solution. To the aqueous silver ammine complex solution thus formed, 75 g of sodium hydroxide was added to control the pH of the solution. Then, 96 ml of industrial formalin serving as a reducing agent was added to the solution. Immediately thereafter, 1.5 g of oleic acid was added to the solution to obtain a silver slurry. Then, the silver slurry thus obtained was filtered, washed with water, dried to obtain a silver powder. Then, the surface of the silver powder thus obtained was smoothed by a surface smoothing process using a high-speed mixer, and the silver powder thus smoothed was classified to remove silver agglomerates having a greater diameter than 8 μm.

The particle diameters of the silver powder thus obtained were measured by Microtrack. As a result, D₁₀ was 0.8 μm, and the mean particle diameter D₅₀ was 1.4 μm. In addition, D₉₀ was 2.5 μm, and the maximum particle diameter Dₘₐₓ was 6.5 μm. Moreover, the specific surface area of the silver powder was 0.75 m²/g, and the tap density of the silver powder was 5.0 g/ml.

To 8 g of the silver powder thus obtained, 2 g of an epoxy resin (Epicoat produced by Japan Epoxy Resin Co., Ltd., (Grade 819 having a viscosity of 0.2 to 0.6 Pa·sec at 25° C.)) was added to prepare a paste. The viscosities of the paste thus prepared were measured by an E-type viscometer at 25° C. and at 0.5 rpm, 1 rpm and 3 rpm, respectively. As a result, the viscosities were 153 Pa·sec, 118 Pa·sec and 79 Pa·sec, respectively.

The particle size of silver particles contained in the paste thus obtained was evaluated by a grind gauge. As a result, the maximum particle diameter Dₘₐₓ was 4 μm, the fourth scratch (the fourth particle diameter from the maximum particle diameter when the particle size of silver particles in the paste was measured by the grind gauge) was 3 μm, and the mean particle diameter D₅₀ was 2 μm.

### COMPARATIVE EXAMPLE 1

A silver powder was produced by the same method as that in Example 1, except that the classification was not carried out The particle diameters of the silver powder thus obtained were measured by Microtrack. As a result, D₁₀ was 0.9 μm, and D₅₀ was 1.4 μm. In addition, D₉₀ was 2.6 μm, and Dₘₐₓ was 6.5 μm. Moreover, the specific surface area of the silver powder was 0.77 m²/g, and the tap density of the silver powder was 5.0 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 159 Pa·sec. 122 Pa·sec and 81 Pa·sec, respectively.

The particle size of silver particles contained in the paste thus obtained was evaluated by a grind gauge. As a result, the maximum particle diameter Dₘₐₓ was 15 μm, the fourth scratch was 8 μm, and the mean particle diameter D₅₀ was 2 μm.

### EXAMPLE 2

To 3600 ml of an aqueous solution containing 12 g/l silver nitrate as silver ions, 180 ml of industrial aqueous ammonia was added to form an aqueous silver ammine complex solution. To the aqueous silver ammine complex solution thus formed, 1 g of sodium hydroxide was added to control the pH of the solution. Then, 192 ml of industrial formalin serving as a reducing agent was added to the solution. Immediately thereafter, 0.1 g of stearic acid was added to the solution to obtain a silver slurry. Then, the silver slurry thus obtained was filtered, washed with water, dried to obtain a silver powder. Then, the surface of the silver powder thus obtained was smoothed by a surface smoothing process using a high-speed mixer, and the silver powder thus smoothed was classified to remove silver agglomerates having a greater diameter than 11 μm.

The particle diameters of the silver powder thus obtained were measured by Microtrack. As a result, D₁₀ was 1.7 μm, and D₅₀ was 3.1 μm. In addition, D₉₀ was 5.0 μm, and Dₘₐₓ was 11.0 μm. Moreover, the specific surface area of the silver powder was 0.28 m²/g, and the tap density of the silver powder was 5.4 g/ml.

To 8 g of the silver powder thus obtained, 2 g of the same body resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 119 Pa sec, 108 Pa·sec and 83 Pa·sec, respectively.

The particle size of silver particles contained in the paste thus obtained was evaluated by a grind gauge. As a result, the maximum particle diameter Dₘₐₓ was 6 μm, the fourth scratch was 5 μm, and the mean particle diameter D₅₀ was 3 μm.

### COMPARATIVE EXAMPLE 2

A silver powder was produced by the same method as that in Example 2, except that pulverization was carried out by means of a food mixer in place of the surface smoothing process and that the classification was not carried out. The particle diameters of the silver powder thus obtained were measured by Microtrack. As a result, D₁₀ was 2.0 μm, and D₅₀ was 4.0 μm. In addition, D₉₀ was 7.1 μm, and Dₘₐₓ was 15.6 μm. Moreover, the specific surface area of the silver powder was 0.26 m²/g, and the tap density of the silver powder was 5.4 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 170 Pa·sec, 142 Pa·sec and 101 Pa·sec, respectively.

The particle size of silver particles contained in the paste thus obtained was evaluated by a grind gauge. As a result, the maximum particle diameter Dₘₐₓ was 14 μm, the fourth scratch was 7 μm, and the mean particle diameter D₅₀ was 3 μm.

### COMPARATIVE EXAMPLE 3

A silver powder was produced by the same method as that in Example 2, except that the classification was not carried out The particle diameters of the silver powder thus obtained were measured by Microtrack. As a result, D₁₀ was 1.7 μm, and D₅₀ was 3.2 μm. In addition, D₉₀ was 5.2 μm, and Dₘₐₓ was 11.0 μm. Moreover, the specific surface area of the silver powder was 0.26 m²/g, and the tap density of the silver powder was 5.8 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 113 Pa·sec, 103 Pa·sec and 86 Pa·sec, respectively.

The particle size of silver particles contained in the paste thus obtained was evaluated by a grind gauge. As a result, the maximum particle diameter Dₘₐₓ was 14 μm, the fourth scratch was 12 μm, and the mean particle diameter D₅₀ was 4 μm.

### EXAMPLE 3

To 3600 ml of an aqueous solution containing 12 g/l silver nitrate as silver ions, 180 ml of industrial aqueous ammonia was added to form an aqueous silver ammine complex solution. To the aqueous silver ammine complex solution thus formed, 7.5 g of sodium hydroxide was added to control the pH of the solution. Then, 192 ml of industrial formalin serving as a reducing agent was added to the solution. Immediately thereafter, 1.5 g of oleic acid was added to the solution to obtain a silver slurry. Then, the silver slurry thus obtained was filtered, washed with water, dried to obtain a silver powder. Then, the surface of the silver powder thus obtained was smoothed by a surface smoothing process using a high-speed mixer, and the silver powder thus smoothed was classified to remove silver agglomerates having a greater diameter than 8 μm.

The particle diameters of the silver powder thus obtained were measured by Microtrack. As a result, D₁₀ was 1.0 μm, and D₅₀ was 1.8 μm. In addition, D₉₀ was 3.0 μm, and Dₘₐₓ was 6.5 μm. Moreover, the specific surface area of the silver powder was 0.46 m²/g, and the tap density of the silver powder was 5.4 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 138 Pa·sec, 115 Pa·sec and 82 Pa·sec, respectively.

The particle size of silver particles contained in the paste thus obtained was evaluated by a grind gauge. As a result, the maximum particle diameter Dₘₐₓ was 5 μm, the fourth scratch was 4 μm, and the mean particle diameter D₅₀ was 2 μm.

### COMPARATIVE EXAMPLE 4

A silver powder was produced by the same method as that in Example 3, except that pulverization was carried out by means of a food mixer in place of the surface smoothing process and that the classification was not carried out. The particle diameters of the silver powder thus obtained were measured by Microtrack. As a result, D₁₀ was 1.1 μm, and D₅₀ was 2.3 μm. In addition, D₁₀ was 4.0 μm, and Dₘₐₓ was 11.0 μm. Moreover, the specific surface area of the silver powder was 0.45 m²/g, and the tap density of the silver powder was 4.7 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 173 Pa·sec, 144 Pa·sec and 111 Pa·sec, respectively.

The particle size of silver particles contained in the paste thus obtained was evaluated by a grind gauge. As a result, the maximum particle diameter Dₘₐₓ was 15 μm, the fourth scratch was 12 μm, and the mean particle diameter D₅₀ was 3 μm.

### COMPARATIVE EXAMPLE 5

A silver powder was produced by the same method as that in Example 3, except that the classification was not carried out The particle diameters of the silver powder thus obtained were measured by Microtrack. As a result, D₁₀ was 0.9 μm, and D₅₀ was 1.8 μm. In addition, D₉₀ was 3.3 μm, and Dₘₐₓ was 9.3 μm. Moreover, the specific surface area of the silver powder was 0.43 m²/g, and the tap density of the silver powder was 5.0 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 132 Pa·sec, 110 Pa·sec and 85 Pa·sec, respectively.

The particle size of silver particles contained in the paste thus obtained was evaluated by a grind gauge. As a result, the maximum particle diameter Dₘₐₓ was 18 μm, the fourth scratch was 12 μm, and the mean particle diameter D₅₀ was 3 μm.

### COMPARATIVE EXAMPLE 6

A silver powder was produced by the same method as that in Example 3, except that pulverization was carried out by means of a food mixer in place of the surface smoothing process. The particle diameters of the silver powder thus obtained were measured by Microtrack. As a result, D₁₀ was 1.0 μm, and D₅₀ was 2.2 μm. In addition, D₉₀ was 3.5 μm, and Dₘₐₓ was 7.8 μm. Moreover, the specific surface area of the silver powder was 0.57 m² /g, and the tap density of the silver powder was 5.4 g/ml.

To 8 g of the silver powder thus obtained, 2 g of the same epoxy resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 166 Pa·sec, 138 Pa·sec and 106 Pa·sec, respectively.

The particle size of silver particles contained in the paste thus obtained was evaluated by a grind gauge. As a result, the maximum particle diameter Dₘₐₓ was 4 μm, the fourth scratch was 3 μm, and the mean particle diameter D₅₀ was 2 μm.

### EXAMPLE 4

To 3600 ml of an aqueous solution containing 12 g/l silver nitrate as silver ions, 100 ml of industrial aqueous ammonia was added to form an aqueous silver ammine complex solution. To the aqueous silver ammine complex solution thus formed, 60 ml of industrial aqueous hydrogen peroxide serving as a reducing agent was added to the solution. Immediately thereafter, 1.5 g of succinic acid was added to the solution to obtain a silver slurry. Then, the silver slurry thus obtained was filtered, washed with water, dried to obtain a silver powder. Then, the surface of the silver powder thus obtained was smoothed by a surface smoothing process using a high-speed mixer, and the silver powder thus smoothed was classified to remove silver agglomerates having a greater diameter than 11 μm.

The particle diameters of the silver powder thus obtained were measured by Microtrack. As a result, D₁₀ was 1.4 μm, and D₅₀ was 2.4 μm. In addition, D₉₀ was 4.4 μm, and Dₘₐₓ was 9.3 μm. Moreover, the specific surface area of the silver powder was 0.46 m²/g, and the tap density of the silver powder was 4.4 g/ml.

To 8 g of the silver powder thus obtained, 2 g of the same body resin as that in Example 1 was added to prepare a paste. The viscosities of the paste thus prepared were measured by the E-type viscometer at 25° C. and at 0.5 rpm, 1 rpm and 3 rpm, respectively. As a result, the viscosities were 132 Pa·sec, 120 Pa·sec and 86 Pa·sec, respectively.

The particle size of silver particles contained in the paste thus obtained was evaluated by a grind gauge. As a result, the maximum particle diameter Dₘₐₓ was 7 μm, the fourth scratch was 6 μm, and the mean particle diameter D₅₀ was 3 μm.

The results in Examples 1 through 4 and Comparative Examples 1 through 5 are shown in Tables 1 and 2.

TABLE 1

| | | | particle diameter | | | | specific | |
|---|---|---|---|---|---|---|---|---|
| | | | (Microtrack) | | | | surface | tap |
| | | | D₁₀ | D₅₀ | D₉₀ | Dₘₐₓ | area | density |
| | smoothing | classification | (μm) | (μm) | (μm) | (μm) | (m²/g) | (g/ml) |
| Ex. 1 | x | x | 0.8 | 1.4 | 2.5 | 6.5 | 0.75 | 5.0 |
| Ex. 2 | x | x | 1.7 | 3.1 | 5.0 | 11.0 | 0.28 | 5.4 |
| Ex. 3 | x | x | 1.0 | 1.8 | 3.0 | 6.5 | 0.46 | 5.4 |
| Ex. 4 | x | x | 1.4 | 2.4 | 4.4 | 9.3 | 0.46 | 4.4 |
| Comp. 1 | x | | 0.9 | 1.4 | 2.6 | 6.5 | 0.77 | 5.0 |
| Comp. 2 | | | 2.0 | 4.0 | 7.1 | 15.6 | 0.26 | 5.4 |
| Comp. 3 | x | | 1.7 | 3.2 | 5.2 | 11.0 | 0.26 | 5.8 |
| Comp. 4 | | | 1.1 | 2.3 | 4.0 | 11.0 | 0.45 | 4.7 |
| Comp. 5 | x | | 0.9 | 1.8 | 3.3 | 9.3 | 0.43 | 5.0 |
| Comp. 6 | | x | 1.0 | 2.2 | 3.5 | 7.8 | 0.57 | 5.4 |

TABLE 2

| | | | | particle size | | |
|---|---|---|---|---|---|---|
| | viscosity | | | (grind gauge) | | |
| | (Pa · sec) | | | Dₘₐₓ | 4th | D₅₀ |
| | 0.5 rpm | 1 rpm | 3 rpm | (μm) | (μm) | (μm) |
| Ex. 1 | 153 | 118 | 79 | 4 | 3 | 2 |
| Ex. 2 | 119 | 108 | 83 | 6 | 5 | 3 |
| Ex. 3 | 138 | 115 | 82 | 5 | 4 | 2 |
| Ex. 4 | 132 | 120 | 86 | 7 | 6 | 3 |
| Comp. 1 | 159 | 122 | 81 | 15 | 8 | 2 |
| Comp. 2 | 170 | 142 | 101 | 14 | 7 | 3 |
| Comp. 3 | 113 | 103 | 86 | 14 | 12 | 4 |
| Comp. 4 | 173 | 144 | 111 | 15 | 12 | 3 |
| Comp. 5 | 132 | 110 | 85 | 18 | 12 | 3 |
| Comp. 6 | 166 | 138 | 106 | 4 | 3 | 2 |

Then, the silver powder obtained in each of Examples 1 through 4 and Comparative Examples 1 through 5 was used for preparing a photosensitive paste of composition shown in Table 3. The preparation of the photosensitive paste was carried out by pre-kneading materials of composition shown in Table 3, and thereafter, kneading them by means of a three-roll mill so as to disperse the silver powder therein.

TABLE 3

| | parts by weight |
|---|---|
| metal powder | 70 |
| photosensitive resin | 20 |
| monomer | 5 |
| photopolymerization | 1 |
| initiator 1 | |
| photopolymerization | 3 |
| initiator 2 | |
| diluent solvent | 10 |
| glass frit | 1 |
| stabilizer | 1 |
| defoaming agent | 0.2 |

As the photosensitive resin, an acrylic copolymer resin having acrylic and carboxyl groups (solid content: 48 wt %, acid value: 115, double bond equivalent: 450) was used. At the monomer, etoxylated trimethylolpropane triacrylate was used. As the photopolymerization initiator (1), 2-methyl-1-[4-(methylthio)phenyl]-2-morpholinopropane-1-on was used. As the photopolymerization initiator (2), 2,4,6-trimethyl benzoyl diphenyl phosphine oxide was used. As the diluent solvent, butylcarbitol acetate was used. As the glass frit, SiO₂.B₂O₃.ZnO glass frit (softening point: 580° C.) was used. As the stabilizer, malonic acid was used. As the defoaming agent, a silicon defoaming agent was used.

The photosensitive paste thus obtained was printed on a glass substrate by using a 400 mesh stainless screen (emulsion thickness: 5 μm), and dried at 80° C. for thirty minutes by means of a hot gas dryer. Then, the film state, sensitivity and linearity of the dried film thus prepared were evaluated.

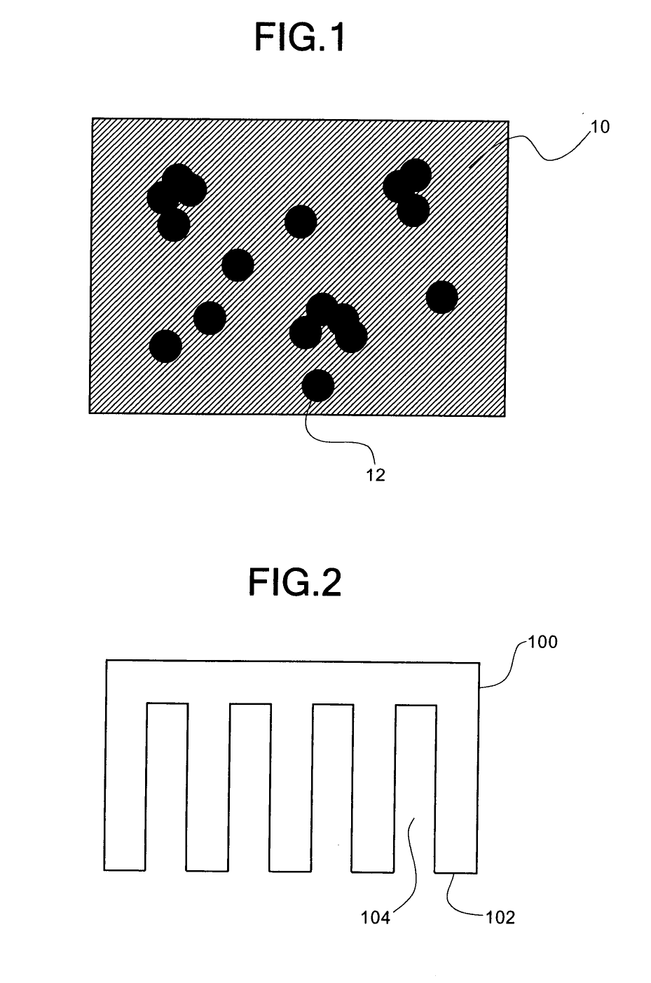

The evaluation of the film state was carried out by observing a sample, which was obtained by exposing the dried film to ultraviolet of 300 mJ/cm², by means of an optical microscope, and determining whether agglomerates 12 having a size of about tens micrometers exist on a uniform film 10 as shown in FIG. 1.

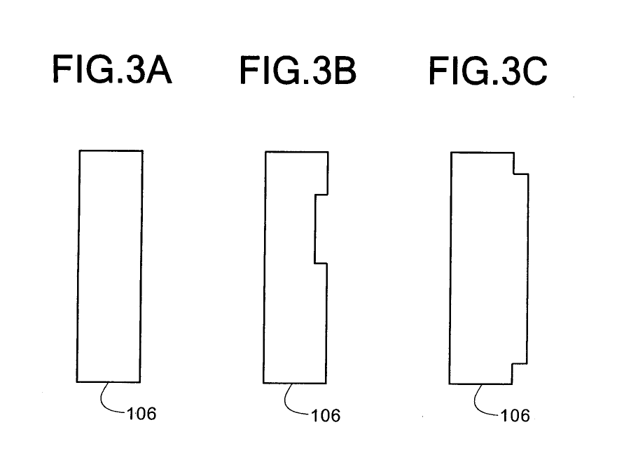

The evaluations of the sensitivity and linearity were carried out with respect to a sample obtained by putting a comb-shaped pattern chromium mask 100 of FIG. 2 on the dried film, exposing the dried film and spray-developing the exposed portion of the dried film with an aqueous solution containing 0.5 wt % of Na₂CO₃ at 30° C. The sensitivity was evaluated by observing the residual portion 106 of the pattern by an optical microscope when the dried film was developed by using the comb-shaped pattern 100 which has lines 102 having a width L (μm) and spaces 104 having a width S (μm) and which satisfies L/S=50/50. The linearity was evaluated by observing the presence of bulging portion (shown in FIG. 3C) and/or broken portion (shown in FIG. 3B) in the developed linear residual portion 106 by means of an optical microscope, and was evaluated to be good if no bulging and broken portions were observed as shown in FIG. 3A.

As a result, in the case of the photosensitive paste obtained from the silver powder in Examples 1 through 4, no agglomerates were observed, so that the film state was good. In addition, the sensitivity was good, and the linearity was also good since the bulging and broken portions of the line were not observed.

In the case of the photosensitive paste obtained from the silver powder in comparative Examples 1, 3 and 5, agglomerates were observed, so that the film state was bad. Although the sensitivity was good, the linearity was bad since the bulging and broken portions of the line were observed.

In the case of the photosensitive paste obtained from the silver powder in Comparative Examples 2 and 4, some agglomerates were observed, so that the film state was bad. In addition, the sensitivity was insufficient, and the linearity was also bad since the bulging and broken portions of the line were observed.

In the case of the photosensitive paste obtained from the silver powder in Comparative Example 6, no agglomerates were observed, so that the film state was good. In addition, the bulging and broken portions of the line were not observed, so that the linearity was good. However, the sensitivity was insufficient.

1-7. (canceled)

8. A silver powder having a mean particle diameter of 0.1 to 10 μm and a maximum particle diameter of not greater than 15 μm, wherein said silver powder has a maximum particle diameter Dₘₐₓ measured by a grind gauge is not greater than 12.5 μm when said silver powder is used for preparing a paste, and
wherein a mixture, which is obtained by mixing and dispersing 80 wt % of said silver powder in 20 wt % of an epoxy resin having a viscosity of 0.2 to 0.6 Pa·sec at 25° C., has a viscosity of not greater than 135 Pa·sec when said viscosity is measured by an E-type viscometer at 25° C. and 1 rpm.

9. A silver powder as set forth in claim 8, wherein said maximum particle diameter of said silver powder is not greater than 11 μm, and said maximum particle diameter Dₘₐₓ measured by said grind gauge is not greater than 7.5 μm.

10. A silver powder as set forth in claim 8, wherein said means particle diameter of said silver powder is not greater than 5 μm.

11. A silver powder having a mean particle diameter of 0.1 to 10 μm and a maximum particle diameter of not greater than 15 μm, wherein said silver powder has a maximum particle diameter Dₘₐₓ measured by a grind gauge is not greater than 12.5 μm when said silver powder is used for preparing a paste, and
wherein a mixture, which is obtained by mixing and dispersing 80 wt % of said silver powder in 20 wt % of an epoxy resin having a viscosity of 0.2 to 0.6 Pa·sec at 25° C., has a viscosity of not greater than 90 Pa·sec when said viscosity is measured by an E-type viscometer at 25° C. and 3 rpm.

12. A silver powder as set forth in claim 11, wherein said maximum particle diameter of said silver powder is not greater than 11 μm, and said maximum particle diameter Dₘₐₓ measured by said grind gauge is not greater than 7.5 μm.

13. A silver powder as set forth in claim 11, wherein said means particle diameter of said silver powder is not greater than 5 μm.

14. A silver powder produced by a method as set forth in claim 1, wherein said silver powder has a maximum particle diameter Dₘₐₓ is not greater than 12.5 μm when said maximum particle diameter Dₘₐₓ is measured by a grind gauge if said silver powder is used for preparing a paste.

15. A silver powder as set forth in claim 14, wherein said maximum particle diameter Dₘₐₓ measured by said grind gauge is not greater than 7.5 μm.
